(19) United States
(12) Patent Application Publication
(10) Pub. No.: US 2018/0203326 A1
(43) Pub. Date: Jul. 19, 2018

(54) MULTI-CRYSTAL FREQUENCY CONVERTER

(71) Applicant: Coherent LaserSystems GmbH & Co. KG, Gottingen (DE)

(72) Inventors: Rüdiger VON ELM, Wielen (DE); Wolf SEELERT, Lubeck (DE)

(21) Appl. No.: 15/409,368

(22) Filed: Jan. 18, 2017

(51) Int. Cl. G02F 1/35; G02F 1/355; G02F 1/37

(52) U.S. Cl. CPC G02F 1/3501; G02F 1/3551; G02F 1/3534; G02F 2201/16; G02F 2001/3507; G02F 2001/3509; G02F 1/37

(57) ABSTRACT

Optical apparatus for performing a frequency-conversion operation on laser-radiation includes three elongated optically nonlinear crystals arranged end-to-end on a propagation-axis of the laser-radiation. Each of the crystals is arranged to perform the same frequency-conversion operation. The length of the crystals is made progressively shorter in the propagation-axis direction.

### TECHNICAL FIELD OF THE INVENTION

The present invention relates in general to frequency-conversion in optically nonlinear crystals. The invention relates in particular to conversion of laser-radiation at one wavelength to radiation at another wavelength using a series of optically nonlinear crystals.

### DISCUSSION OF BACKGROUND ART

Optical frequency conversion in optically nonlinear crystals is a process typically used to indirectly generate laser-radiation having a wavelength that cannot practically be generated directly from any laser gain-medium. This process is extensively used to generate laser-radiation having a wavelength in the ultraviolet (UV) region of the electromagnetic spectrum.

By way of example, laser-radiation having a wavelength of 1064 nanometers (nm) can be converted to radiation having a wavelength of 532 nm by frequency doubling in one optically nonlinear crystal. The 532 nm radiation can be converted to radiation having a wavelength of 266 nm or 355 nm in another optically nonlinear crystal by respectively frequency-doubling or sum-frequency mixing.

The frequency-conversion process in an optically nonlinear crystal has a conversion-efficiency (converted-power out versus input-power) determined by a number of factors other than basic properties of the optically nonlinear material of the crystal. One important factor is electric-field intensity of the radiation to be converted, on which the conversion efficiency is directly dependent. Another important factor is the type and accuracy of so called “phase matching” which can be described simply as arranging the optically nonlinear to crystal to maximize interaction of the converted frequency with the input frequency.

Phase-matching is dependent, inter alia, on the orientation of the axes of the crystal relative to the propagation direction, and on temperature of the crystal to a degree dependent on the type of phase-matching employed. Assuming temperature and phase-matching are optimized, one way of increasing frequency-converted output power as a fraction of input power would be to extend the length of the optically-nonlinear crystal. As nominally transparent optically nonlinear crystals still have a finite absorption coefficient, particularly for shorter-wavelengths, crystal temperature can increase dynamically during passage of radiation being converted. In a long crystal, this can result in the crystal temperature increasing to a point where the input and converted frequencies become progressively out of phase, thereby reducing interaction of the input and converted frequencies. This is often termed the “thermal de-phasing problem” by practitioners of the art.

One prior-art solution to this problem of extending crystal length while limiting thermal dephasing, is to replace a long crystal with two or more equal-length crystals having a total length about that of the long crystal. This is described in certain patent and open-literature references, which are a part of an information disclosure statement appended to this application.

Applicants have experimented with this solution and found that results were inconsistent and fell short of expectations. Applicants determined that a more detailed analysis of the thermal-dephasing problem was required to determine a solution that could provide consistent anticipated results.

### SUMMARY OF THE INVENTION

In one aspect, optical apparatus in accordance with the present invention for performing a frequency-conversion operation comprises first and second optically nonlinear crystals located on a propagation-axis of the laser-radiation and numbered in consecutive numerical order in the propagation-axis direction. Each of the optically nonlinear crystals arranged to perform the frequency-conversion operation. The second optically nonlinear crystal has a length less than that of the first optically nonlinear crystal.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1A is a graph schematically illustrating rate of absorption of laser-radiation power as a function of length along a propagation axis z in an optically nonlinear crystal.

FIG. 1B schematically illustrates the optically nonlinear crystal of FIG. 1A having a length L_{S}.

FIG. 1C schematically illustrates three optically nonlinear crystals each having a length of about L_{S}/3 replacing the crystal of FIG. 1B, as taught in prior-art references.

FIGS. 2A-C schematically illustrate one preferred embodiment of a multi-crystal frequency converter in accordance with the present invention, wherein a crystal of length L_{S} is replaced by first, second, and third crystals numbered in the propagation direction and having a total length L_{S}, but with the lengths of the crystals progressively decreasing in the propagation-axis direction.

FIGS. 3A-C schematically illustrate another preferred embodiment of a multi-crystal frequency converter in accordance with the present invention, similar to the embodiment of FIGS. 2A-C but wherein the second and third crystals are of equal length and have a combined length less than that of the first crystal.

FIGS. 4A-C schematically illustrate still another preferred embodiment of a multi-crystal frequency converter in accordance with the present invention, similar to the embodiment of FIGS. 2A-C, but with the first, second, and third crystals held at first, second, and third different nominal phase-matching temperatures.

FIG. 5 schematically illustrates characteristics Tᵢₙ, and Tₒᵤₜ and ρᵢₙ and ρₒᵤₜ for one optically nonlinear crystal, which characteristics are used for computational purposes in a graphical determination of a suitable crystal length.

FIG. 6 is a graph schematically illustrating (ρₒᵤₜ−ρᵢₙ) as a function of crystal length, which graph is used in the above-mentioned graphical determination of crystal length.

FIGS. 7A and 7B schematically illustrate the graph of FIG. 6, overlaid with the graph of FIG. 1A in the above-mentioned graphical determination of crystal length

### DETAILED DESCRIPTION OF THE INVENTION

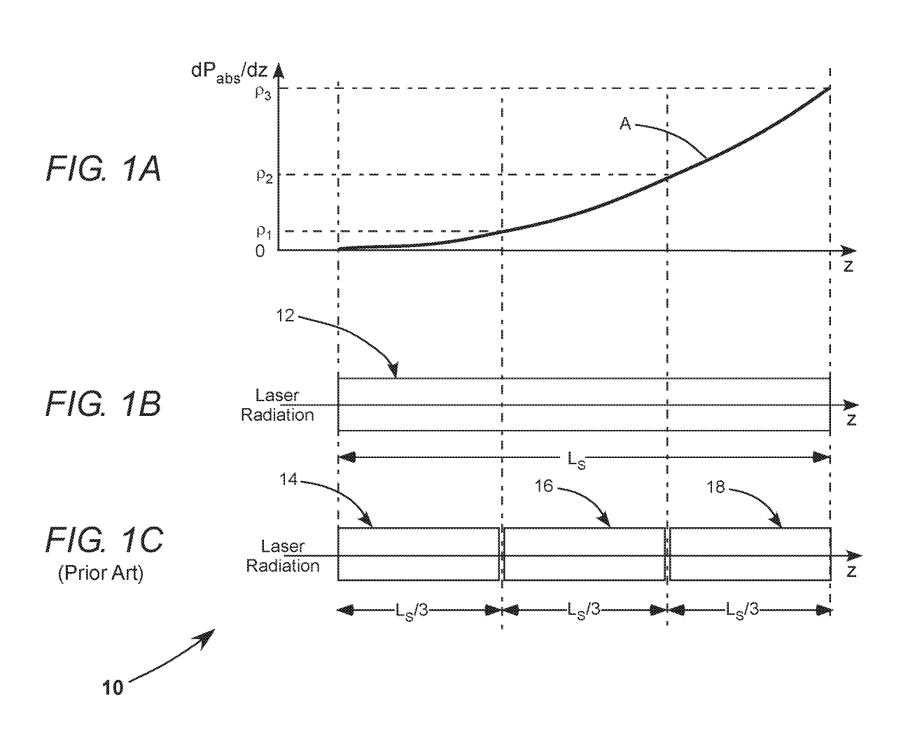

Beginning with an analysis of a prior-art solution to the thermal dephasing problem, FIG. 1A is a graph schematically illustrating rate of absorption of laser-radiation power (dP_{abs}/dz) as a function of length along a propagation axis z (Curve A) in an optically nonlinear crystal 12 having a length L_{S} schematically depicted in FIG. 1B. In this case, the prior-art solution 10 to the thermal dephasing problem is schematically depicted in FIG. 1C and involves replacing crystal 12 with three crystals 14, 16, and 18, each having a length of about L_{S}/3.

It should be noted here that in FIG. 1C, crystals 14, 16, and 18 are depicted as arranged essentially end-to-end along axis z. This is preferred for minimizing dispersion and consequent phase mismatching in air between the crystals. Those skilled in the art to which the present invention pertains will recognize that there could be relay optics between the crystals to refocus radiation from one crystal into the next crystal. A detailed description of such relay optics is not necessary for understanding principles of the present invention and, accordingly, is not presented herein.

In this prior-art description and in examples of inventive solutions to the thermal dephasing problem described further hereinbelow, it is assumed that radiation having a “fundamental” wavelength is being converted by frequency-doubling to UV wavelength radiation in each crystal. The fundamental wavelength, in this instance, may itself have been generated by frequency conversion from a different fundamental wavelength as discussed above.

The power-absorption rate along the z-axis is a function of fundamental wavelength power (P_{F}) and UV wavelength power (P_{UV}) that can be approximated by a quadratic equation:

dP_{abs}/dz=ρ=α_{F}P_{F}+α_{UV}P_{UV}+β₁P_{F}P_{UV}+β₂P_{UV}² (1)

where α_{F} and α_{UV} are linear absorption coefficients at the fundamental wavelength and UV wavelength, respectively, and β1 and β2 are two-photon absorption coefficients. The absorption coefficients are characteristic of the nonlinear crystal material.

Thermal analysis for this and inventive examples herein is based on assumption that crystals are in the form of cylinders having a circular cross-section with a radius of about 2.5 millimeters (mm) and that fundamental wavelength power in the crystal is in the form of a collimated beam having a diameter of 200 micrometers (μm). This is a less than rigorous assumption, as focused beam-waists for coherent radiation have a hyperbolic form in the z-axis direction. The assumption is, however, sufficiently adequate to identify the problem and formulate inventive solutions. Thermal analysis indicates that radial thermal gradients do not contribute significantly to the thermal dephasing problem.

FIG. 1A clearly illustrates the quadratic form (curve A) of increasing power-absorption rate with propagation distance in crystal 12. This will of course be create a corresponding quadratic form of temperature increase with propagation direction, which creates the thermal dephasing.

Comparing the three equal-length crystals of FIG. 1C with the graph of FIG. 1A clearly illustrates shortcomings of the prior-art solution to the thermal dephasing problem. It can be seen that the difference in exit rates between entrance and exit faces of the crystals increases progressively from one crystal to the next, that is, ρ₁<(ρ₂−ρ₁)<(ρ₃−ρ₂). That means that the temperature difference between the entrance and exit faces of the crystals also increases progressively from one crystal to the next. Thermal dephasing effects of this nature can be somewhat mitigated, as suggested in one or more of the above-referenced prior-art documents, by selecting different nominal phase-matching temperatures for the crystals. Nevertheless, this may still provide less than an ideal solution.

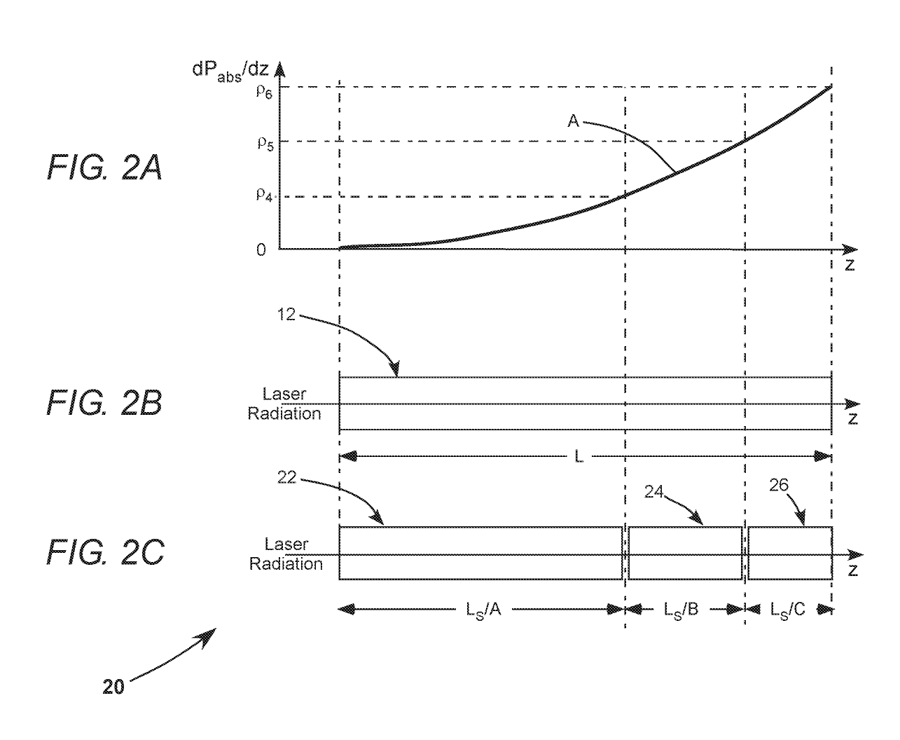

Turning now to a description the present invention, FIG. 2A, FIG. 2B, and FIG. 2C schematically illustrate one preferred embodiment 20 of a multi-crystal frequency-converter in accordance with the present invention. In this embodiment, crystal 12 of length L_{S} is replaced by crystals 22, 24, and 26 numbered in the propagation direction. The crystals having a total length L_{S}, but the lengths of the crystals, L_{S}/A, L_{S}/B, and L_{S}/C, respectively, progressively decrease in the propagation-axis direction, i.e., L_{S}/A>L_{S}/B>L_{S}/C. In this instance the combined length of crystal 24 and 26 (L_{S}/B+L_{S}/C) is less than the length of crystal 22 (L_{S}/A) although that is not a necessary limitation and should not be construed as limiting. The crystal lengths in embodiment 20 of the present invention are selected somewhat arbitrarily, here, such that the difference in power-absorption rate between the exit face and entrance face of each of crystals is the same. In terms of the graph of FIG. 2A, (ρ₆−ρ₅)=(ρ₅−ρ₄)=ρ₄.

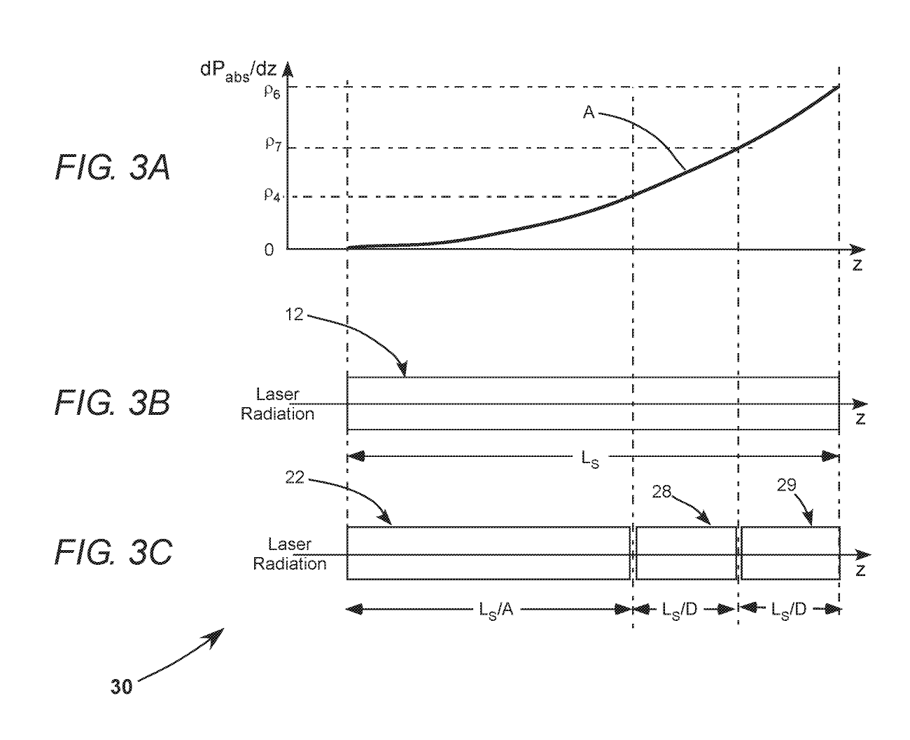

FIG. 3A, FIG. 3B, and FIG. 3C schematically illustrate another preferred embodiment 30 of a multi-crystal frequency-converter in accordance with the present invention. Embodiment 30 is similar to embodiment 20 of FIGS. 2A-C with an exception that crystals 24 and 26 thereof are replaced in embodiment 30 by crystals 28 and 29 having an equal length L_{S}/D. The combined length of crystals 28 and 29 (2*L_{S}/D) is less than the length of crystal 22 (L_{S}/A). Here again, this should not be construed as a limiting condition.

It is expected that embodiment 30 may be only marginally less effective at providing a solution to thermal dephasing than embodiment 20. Embodiment 30 offers a practical advantage in that crystals of only two different lengths are required, thereby offering potential economies of scale in the production of the two shorter crystals.

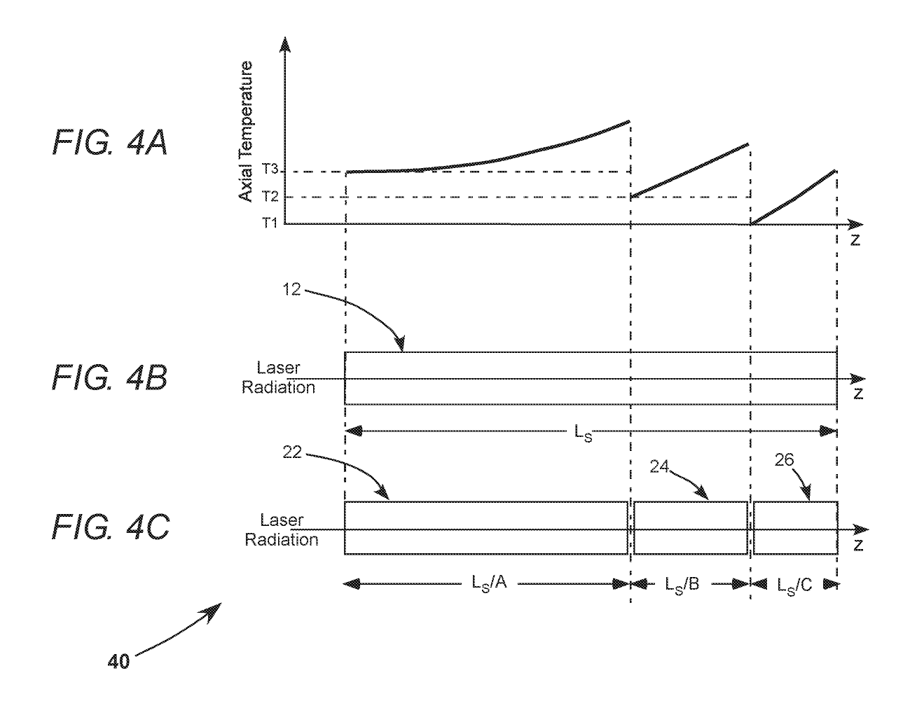

FIG. 4A, FIG. 4B, and FIG. 4C schematically illustrate yet another preferred embodiment 40 of a multi-crystal frequency-converter in accordance with the present invention. Embodiment 40 is essentially embodiment 20 of FIGS. 2A-C with each of the crystals operated at a different nominal phase-matching temperature. FIG. 4A schematically illustrates temperature change in the z-axis direction corresponding to the power-absorption rate as a function of z-axis position of FIG. 2A.

In the example of FIGS. 4A and 4C, crystals 22, 24, and 26 are held at nominal phase-matching temperatures of T3, T2, and T1, respectively. These particular temperatures are selected arbitrarily for illustration purposes. Those skilled in the art will recognize, however, that having selected the crystal lengths according to whatever criterion, optimization of the apparatus is easily carried out by experiment to determine suitable phase-matching temperatures.

In above-described embodiments of the present invention, the lengths of the multiple crystals are selected, by various arbitrary or empirical criteria, as fractions of the length of a hypothetical, long single crystal. Set forth below is a description of a more analytical method of selecting crystal lengths, albeit with a somewhat arbitrary goal that each of the multiple crystals crystal contributes equally the thermal dephasing.

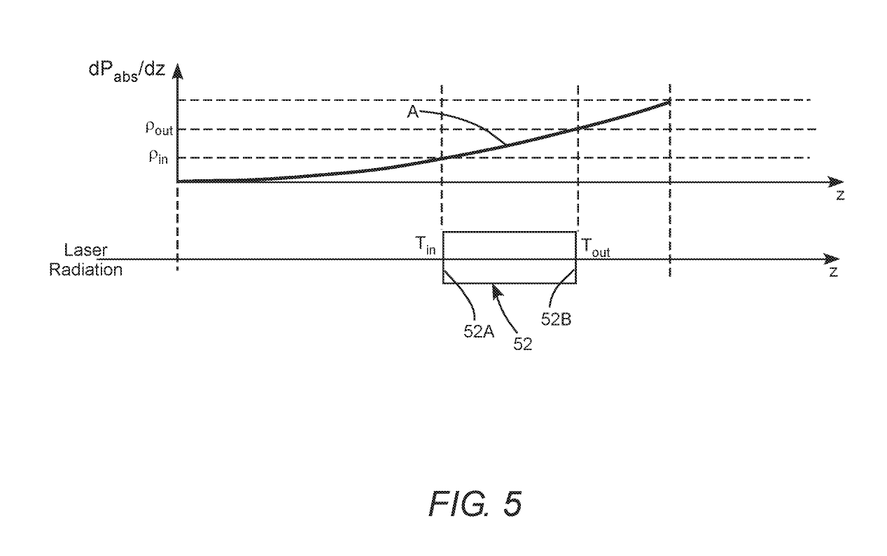

FIG. 5 schematically illustrates a “second” crystal 52 compared with a graph of dP_{abs}/dz (p) as a function of length for the crystal material. The crystal is characterized as having a length L with a temperature and power-absorption rate Tᵢₙ and ρᵢₙ respectively at entrance face 52A of the crystal, and temperature and power-absorption rate Tₒᵤₜ and ρₒᵤₜ respectively at exit face 52B of the crystal. These temperature and power-absorption rate values are referred to in the analytic approach to determining optimum crystal length.

The goal of having each crystal in a sequence thereof contribute equally to the thermal dephasing can be expressed mathematically by defining a constant tolerable phase-mismatch contribution:

$${ϕ}_{max} = \frac{L Δ K}{2} \qquad ( 2 )$$

where Δk is the maximum mismatch between the wavevectors of the fundamental wavelength radiation and the converted radiation over the crystal length and L is the crystal length.

The phase-mismatch contribution φₘₐₓ can also be expressed as:

φₘₐₓ=a TR=a(Tₒᵤₜ−Tᵢₙ)L=b(ρₒᵤₜ−ρᵢₙ)L (3)

where TR is the “temperature range” for the crystal material, and both a and b are constants that correspond to the tolerable phase-mismatch. TR is typically expressed in units of Kelvin·centimeters (K·cm). The value of TR for a particular crystal material is available in software SNLO available online from www.as-photonics.com. This software is extensively used by those concerned with frequency-conversion in optically nonlinear crystals. The values of constants a and b are user-selected.

From equation (3), an expression for a suitable crystal-length can be formulated as follows:

$$L = \frac{aTR}{b ( {ρ}_{out} - {ρ}_{in} )} \qquad ( 4 )$$

The crystal-length selection for a series of crystals can be graphically determined by first rewriting equation (4) to represent (ρₒᵤₜ−ρᵢₙ) as a function of crystal length L. This provides an equation:

$$( {ρ}_{out} - {ρ}_{in} ) = \frac{aTR}{bL} \qquad ( 5 )$$

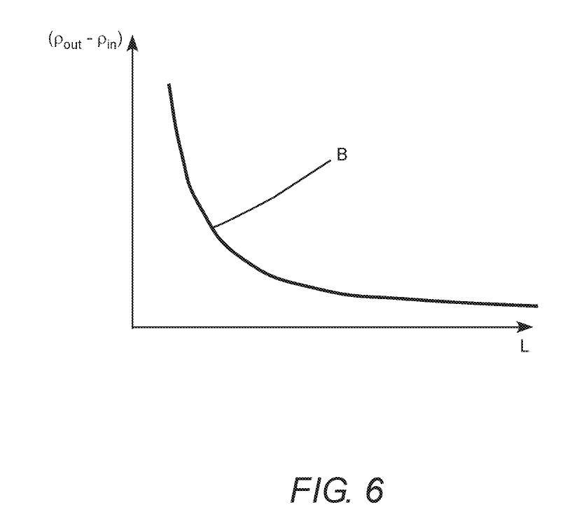

FIG. 6 schematically illustrates a curve of hyperbolic form (curve B) obtained by plotting (ρₒᵤₜ−ρᵢₙ) as a function of L according to equation (5).

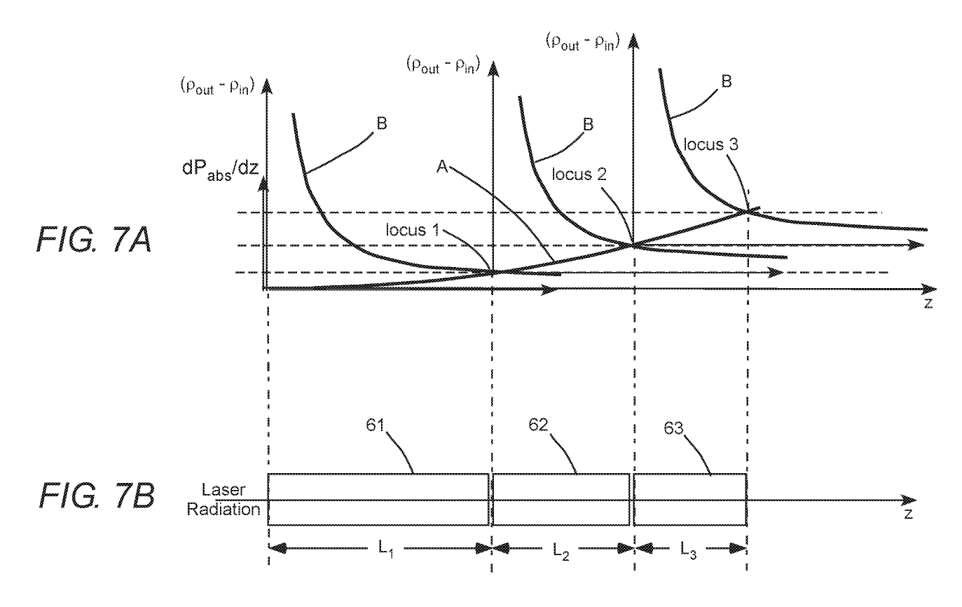

FIG. 7A and FIG. 7B schematically illustrate how the hyperbolic plot (curve B) of FIG. 6 can be used with the plot of (dP_{abs}/dz versus L), (curve A), as a function of z, i.e., L, to determine crystal lengths for three series arranged crystals 61, 62 and 63 (see FIG. 7B) according to the above discussed equal phase-mismatch contribution (EPMC) criterion. In order to determine the length of the crystals, the origin of curve B is first co-located with origin of curve A. Curves A and B intersect at locus 1. The distance L₁ between the origin of curve B and the z-coordinate of locus 1 is the desired length for crystal 61 according to the (EPMC) criterion.

Next, the origin of curve B is moved to locus 1 and curves A and B again intersect, here, at a second locus (locus 2). The z-axis difference between locus 2 and locus 1 determines length L₂ of crystal 62. Finally, the origin of curve B is moved to locus 2 and curves A and B again intersect at a third locus (locus 3). The z-axis difference between locus 3 and locus 2 determines length L₃ of crystal 63. In this example, the sum of the lengths of crystals 62 and 63 is greater than the length of crystal 61. This again should not be construed as a limiting condition.

Recapitulating, the present invention is described above in terms of embodiments wherein a particular frequency-conversion operation for laser-radiation is performed in two or more elongated optically nonlinear crystals arranged is series along a propagation-axis of the radiation. It is emphasized here that the same frequency-conversion operation is performed in each of the crystals. Here, the terminology “same frequency conversion operation” means that each converts the same first frequency to the same second frequency.

The at least two crystals can be identified as first and second crystals, numbered in consecutive numerical order in the propagation-axis direction. In all embodiments of the present invention, the second crystal has a length less than that of the first crystal, with the lengths selected according to any of the above-described criteria. Preferably, but not necessarily, in a series of more than two crystals, each crystal should have a length less than that of a previous adjacent crystal. In such an arrangement, each crystal will have a length at least about 10% less than the length of a previous adjacent crystal in the series.

Those skilled in the art will recognize from the description of the present invention presented above, that embodiments and principles of the invention are applicable to frequency-doubling operations and sum-frequency mixing operations. Principles are also applicable for type-1 or type-2 frequency-conversion operations, critical or non-critical, and adjacent crystals in a series may have different axis-orientations for compensating spatial walk-off between interacting frequencies.

In summary, the present invention is described above with reference to preferred embodiments. The invention, however, is not limited by the embodiments described herein, but is limited only by the claims appended hereto.

1. Apparatus for performing a frequency-conversion operation on laser-radiation, the apparatus comprising:
first and second optically nonlinear crystals located on a propagation-axis of the laser-radiation and numbered in consecutive numerical order in the propagation-axis direction, with each of the optically nonlinear crystals arranged to perform the same frequency-conversion operation; and
wherein the second optically nonlinear crystal has a length less than that of the first optically nonlinear crystal.

2. The apparatus of claim 1, wherein the second optically nonlinear crystal has a length at least 10% less than that of the first optically nonlinear crystal.

3. The apparatus of claim 1, wherein the frequency-conversion operation is frequency-doubling.

4. The apparatus of claim 1, wherein the frequency-conversion operation is sum-frequency mixing.

5. The apparatus of claim 1, wherein the optically nonlinear crystals are arranged end-to-end on the propagation axis.

6. The apparatus of claim 1, further including a third optically nonlinear crystal located on the propagation-axis following the second crystal and arranged to perform the frequency-conversion operation.

7. The apparatus of claim 6, wherein the third optically nonlinear crystal has a length less than that of the second optically nonlinear crystal.

8. The apparatus of claim 6, wherein the third optically nonlinear crystal has a length about equal to that of the second optically nonlinear crystal.

9. Apparatus for converting radiation having a first frequency to radiation having a second frequency different from the first frequency, the apparatus comprising:
first and second optically nonlinear crystals located on a propagation-axis of the laser-radiation and numbered in consecutive numerical order in the propagation-axis direction, with each of the optically nonlinear crystals arranged to convert the first-frequency radiation to the second-frequency radiation; and
wherein the second optically nonlinear crystal has a length less than that of the first optically nonlinear crystal.

10. The apparatus of claim 9, wherein the second optically nonlinear crystal has a length at least 10% less than that of the first optically nonlinear crystal.

11. The apparatus of claim 9, wherein the second frequency is twice the first frequency.

12. The apparatus of claim 9, wherein the optically nonlinear crystals are arranged end-to-end on the propagation axis.

13. The apparatus of claim 9, further including a third optically nonlinear crystal located on the propagation-axis following the second crystal and arranged convert the first-frequency radiation to second frequency radiation.

14. Apparatus for converting radiation having a first frequency to radiation having a second frequency different from the first frequency, the apparatus comprising:
a plurality of nonlinear crystals located in sequence on propagation-axis of the laser-radiation, with each thereof arranged to convert the first-frequency radiation to second-frequency radiation; and
wherein the optically nonlinear crystals are designated the first through the Nth in consecutive numerical order in the propagation-axis direction, with the second through the Nth optically nonlinear crystals each being shorter than a previous optically nonlinear crystal in the sequence.

15. The apparatus of claim 14, wherein the second through the Nth optically nonlinear crystals are each about 10% shorter than a previous optically nonlinear crystal in the sequence

16. The apparatus of claim 14, wherein the frequency-conversion operation is frequency-doubling.

17. The apparatus of claim 14, wherein the optically nonlinear crystals are arranged end-to-end on the propagation axis.

18. The apparatus of claim 13, wherein the third optically nonlinear crystal has a length less than that of the second optically nonlinear crystal.

19. The apparatus of claim 13, wherein the third optically nonlinear crystal has a length about equal to that of the second optically nonlinear crystal.
